(19) United States
(12) Patent Application Publication
(10) Pub. No.: US 2013/0329931 A1
(43) Pub. Date: Dec. 12, 2013

(54) MICROPHONE ASSEMBLY AND ELECTRONIC DEVICE USING SAME

(71) Applicants: FIH (Hong Kong) Limited, Kowloon (HK); SHENZHEN FUTAIHONG PRECISION INDUSTRY CO., LTD., Shenzhen (CN)

(72) Inventors: ZHENG-PING TAN, Shenzhen (CN); YAO WANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/911,347

(22) Filed: Jun. 6, 2013

(30) Foreign Application Priority Data
Jun. 12, 2012 (CN) 2012101920083

(51) Int. Cl. H04R 1/02

(52) U.S. Cl. CPC H04R 1/02
USPC 381/355

(57) ABSTRACT

A microphone assembly includes a base and a microphone cover. The base defines a receiving groove for receiving a microphone and a first recess communicating with the receiving groove. The microphone cover defines a second recess covering the base. The first recess and the second recess of the microphone cover together define a sound channel communicating with the receiving groove therebetween, and running through an end of the base.

### BACKGROUND

1. Technical field

The disclosure generally relates to microphone assemblies, and particularly to a microphone assembly used in an electronic device.

2. Description of the Related Art

A typical microphone in an electronic device, such as a mobile phone, often requires a sound channel and a microphone cover sealing the sound channel. However, the microphone cover may take up most of the inner space of the electronic device which does not allow for space for the actual microphone in thin portable electronic devices.

Therefore, there is room for improvement within the art.

### BRIEF DESCRIPTION OF THE DRAWINGS

Many aspects of an exemplary microphone assembly can be better understood with reference to the following drawings. The components in the drawings are not necessarily drawn to scale, the emphasis instead being placed upon clearly illustrating the principles of the exemplary microphone assembly. Moreover, in the drawings, like reference numerals designate corresponding parts throughout the several views.

Wherever possible, the same reference numbers are used throughout the drawings to refer to the same or like elements of an embodiment.

FIG. 1 is an exploded view of a microphone assembly used in an electronic device, according to an exemplary embodiment.

FIG. 2 is similar to FIG. 1, but shown from another angle.

FIG. 3 is an assembled view of the electronic device shown in FIG. 1.

FIG. 4 is similar to FIG. 3, but shown from another angle.

FIG. 5 is a cross-sectional view of the microphone assembly along line V-V of FIG. 3.

### DETAILED DESCRIPTION

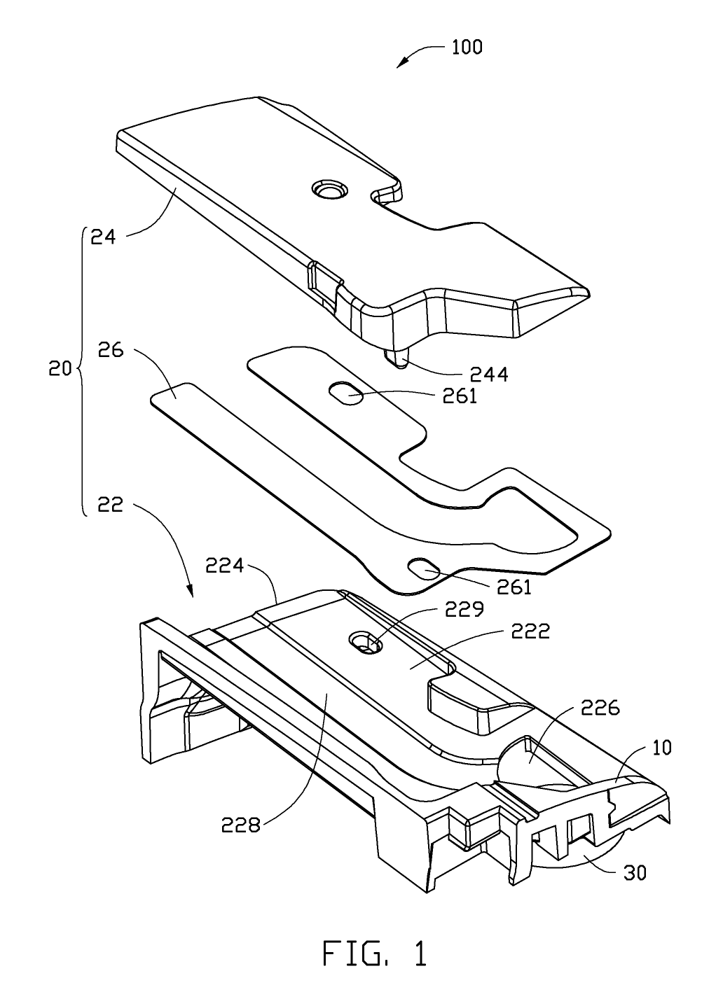

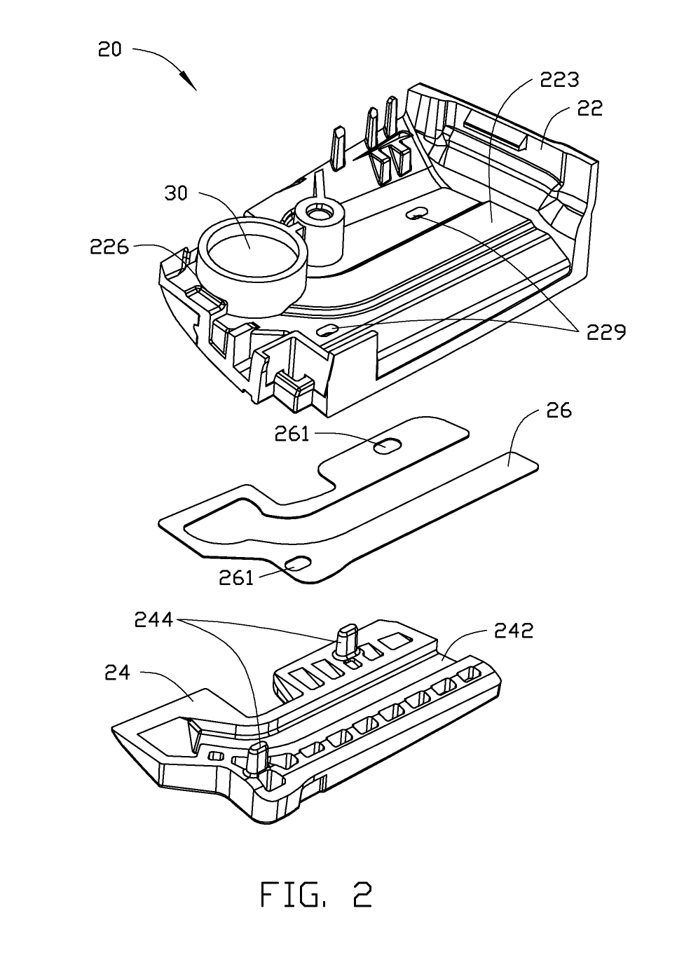

According to an exemplary embodiment, FIGS. 1-2 show a microphone assembly 20 used in an electronic device 100 such as a mobile phone, a personal digital assistant (PDA). The electronic device 100 includes a housing 10, the microphone assembly 20, and a microphone 30 (schematically shown). In this exemplary embodiment, the housing 10 is a back housing of the electronic device 100. The microphone assembly 20 includes a base 22 and a microphone cover 24. The microphone cover 24 is attached to the base 22 by, e.g., hot melting. An adhesive layer 26 is located between the base 22 and the microphone cover 24 for seamlessly connecting the base 22 and the microphone cover 24. In the embodiment, the adhesive layer 26 is a double-sided adhesive (e.g. tape). The adhesive layer 26 defines two openings 261.

The base 22 can be one portion of the housing 10, or an independent component attached to the housing 10. In the embodiment, the base 22 is integral with the housing 10. The base 22 includes a first surface 222, a second surface 223 opposite to the first surface 222, and an end surface 224. The end surface 224 connects the first surface 222 to the second surface 223. In this exemplary embodiment, the first surface 222 is an external surface of the housing 10, and the second surface 223 is an internal surface of the housing 10. The first surface 222 defines a receiving groove 226 and a first recess 228 communicating with the receiving groove 226. The first recess 228 runs through the end surface 224. The base 22 defines two through holes 229, and the two through holes 229 are separated by the first recess 228.

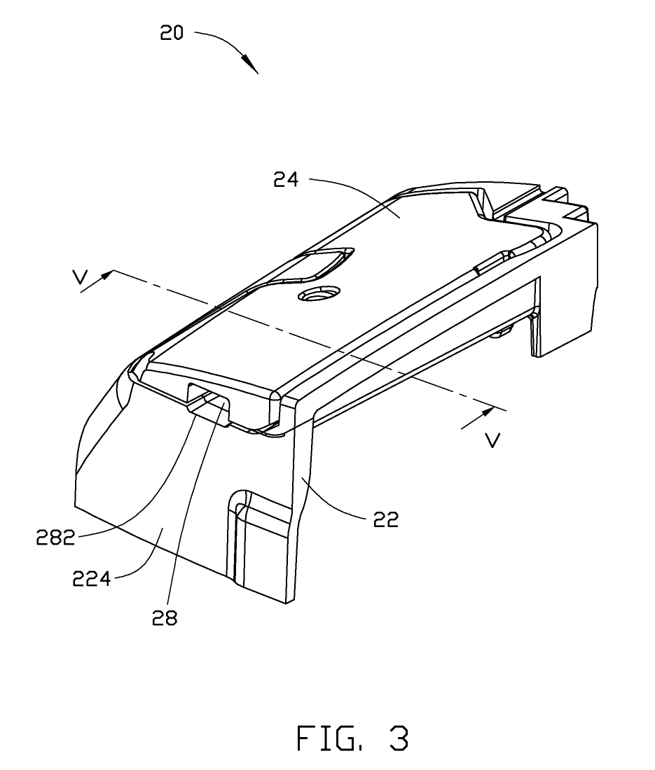

The microphone cover 24 is covered on the first surface 222 of the base 22. The microphone cover 24 includes two posts 244 and defines a second recess 242. Each post 244 passes through one of the through holes 229 and the posts 244 are melted to fix the microphone cover 24 on the base 22. The second recess 242 and the first recess 228 together define a sound channel 28 (shown in FIG. 3) therebetween. The sound channel 28 communicates with the receiving groove 226 for transmitting sound to the microphone 30 from external of the electronic device 100.

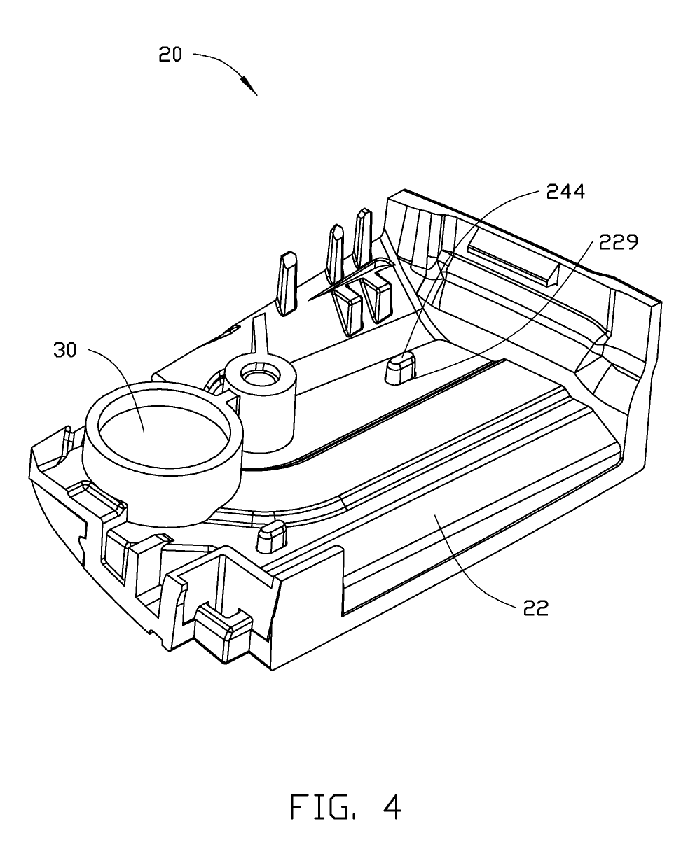

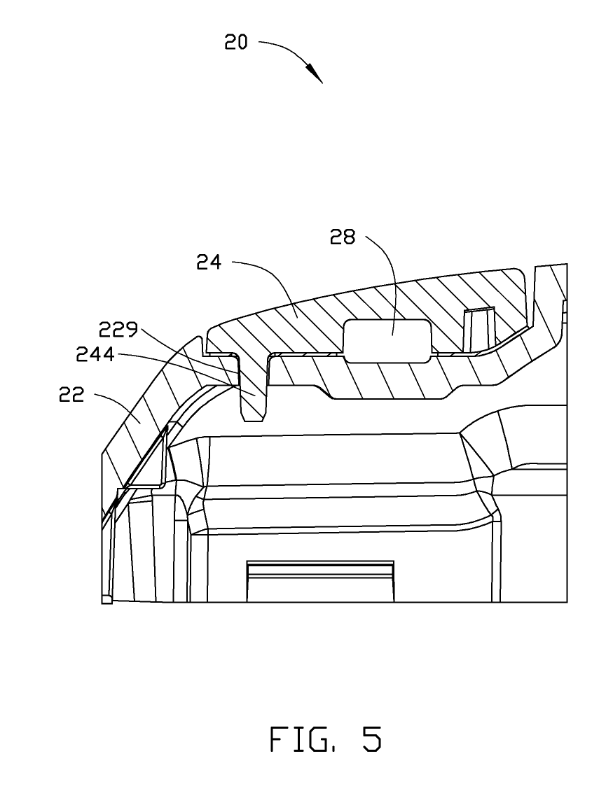

FIGS. 3-5 show that in assembly, the microphone 30 is positioned on the second surface 223 of the base 22, and communicates with the receiving groove 226. The adhesive layer 26 is attached to the microphone cover 24 and surrounds the second recess 242. The posts 244 respectively pass through the openings 261. Each post 244 further passes through the through hole 229, and the microphone cover 24 tightly presses on the base 22 under an external force. The posts 224 are melted to fix the microphone cover 24 on the base 22. The sound channel 28 runs through the end surface 224 to form a sound hole 282. The sound hole 282 is located at the bottom of the electronic device 100 and is not easily blocked by face or finger, and then the communication quality is improved.

The sound channel 28 is defined between the base 22 and the microphone cover 24 covering on the base 22. The microphone cover 24 is attached to the first surface 222 which is an external surface of the housing 10, and then the inner space of the housing 10 is saved. The adhesive layer 26 located between the base 22 and the microphone cover 24 improves sealing performance of the sound channel 28.

In another exemplary embodiment, one of the first recess 228 or the second recess 242 can be omitted.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A microphone assembly, comprising:
a base including a microphone at a first surface, a first recess at a second surface, and a receiving groove communicating with the microphone and the first recess; and
a microphone cover defining a second recess;
wherein the microphone cover covers on the base; the first recess and the second recess together define a sound channel, one end of the sound channel communicating with the microphone by the receiving groove therebetween, another end of the sound channel runs through an end of an external of the base.

2. The microphone assembly as claimed in claim 1, wherein an adhesive layer is located between the base and the microphone cover.

3. The microphone assembly as claimed in claim 1, wherein the base defines a through hole; the microphone cover comprises a post, the post passes through the through hole and is melted to fix the microphone cover on the base.

4. The microphone assembly as claimed in claim 3, wherein an adhesive layer defining an opening is located between the base and the microphone cover, and the post pass through the opening.

5. An electronic device, comprising:
a housing;
a microphone; and
a microphone cover covering on the housing, the housing defining a receiving groove for receiving a microphone and a first recess communicating with the receiving groove;
wherein the first recess and the microphone cover together define a sound channel communicating with the receiving groove therebetween, the sound channel runs through an end of the housing.

6. The electronic device as claimed in claim 5, wherein an adhesive layer is located between the housing and the microphone cover.

7. The electronic device as claimed in claim 5, wherein the housing defines a through hole; the microphone cover comprises a post, the post passes through the through hole and is melted to fix the microphone cover on the housing.

8. The electronic device as claimed in claim 7, wherein an adhesive layer defining an opening is located between the base and the microphone cover, and the post pass through the opening.

9. The electronic device as claimed in claim 5, wherein the microphone cover defines a second recess, the first recess and the second recess together define the sound channel therebetween.
